(19) United States
(12) Patent Application Publication
(10) Pub. No.: US 2013/0038276 A1
(43) Pub. Date: Feb. 14, 2013

(54) SECONDARY COIL STRUCTURE OF INDUCTIVE CHARGING SYSTEM FOR ELECTRIC VEHICLES

(71) Applicant: Steven Raedy, Raleigh, NC (US)

(72) Inventor: Steven Raedy, Raleigh, NC (US)

(73) Assignee: EVATRAN LLC, Wytheville, VA (US)

(21) Appl. No.: 13/207,714

(22) Filed: Aug. 11, 2011

(51) Int. Cl. H02J 7/00

(52) U.S. Cl. 320/108

(57) ABSTRACT

A secondary coil structure for an electric vehicle charging system is characterized by a flexible sheet of synthetic plastic material which acts as a substrate for a coil connected with the top surface of the sheet. The coil has an axis generally normal to the sheet. A second sheet of material is connected with the first sheet with the coil arranged between the sheets. The secondary coil may be configured to match the configuration of a component of the vehicle with which the secondary coil is connected. When electric current is introduces into the coil, the coil generates an elongated magnetic field with a lower maximum value in the vicinity of the vehicle components than that created by a conventionally wound coil, thereby minimizing heat generated in steel components of the vehicle body.

### BACKGROUND OF THE INVENTION

Electric vehicle energy storage systems are normally recharged using direct contact conductors between an alternating current (AC) source such as is found in most homes in the form of electrical outlets; nominally 120 or 240 VAC or using inductive battery charging devices. Inductive charging devices utilize a transformer having primary and secondary windings to charge the battery of the vehicle. The primary winding is mounted in a stationary charging unit where the vehicle is stored and the secondary winding is mounted on the vehicle.

To maximize efficiency, it is important that the secondary winding on the vehicle be aligned with and in close proximity to the primary winding in the stationary charging unit. This requirement presents some difficulties in the structure of the secondary coil. If the coil extends too far below the vehicle, it can be damaged by striking road objects when the vehicle is in operation. On the other hand, if the secondary coil is too close to the vehicle, the magnetic field generated by current within the coil may heat the surrounding metal of the vehicle to dangerous levels. In addition, the heat reduces the efficiency of energy transfer during the charging process. The present invention relates to an improved coil construction for the vehicle mounted secondary coil of an inductive charging system.

### BRIEF DESCRIPTION OF THE PRIOR ART

Various coil configurations are well known in the art. Most comprise a plurality of stacked windings of wire about a central axis so that the coil has a donut or annular configuration. The coil has both a lateral thickness and a vertical height which makes the coil rather bulky for certain installations such as when mounted on a vehicle for inductive charging.

Also known are coil configurations with reduced height. For example, the Baarman US patent application publication No. 2009/0085706 discloses a printed circuit board coil formed of a plurality of alternating conductor and insulating layers which are interconnected to form the coil. The Kato et al US patent application publication No. 2008/0164840 discloses a multi-layered coil in which multiple flexible printed circuit boards each having a planar coil pattern and a spirally formed conductor patter which are stacked on top of one another.

While these prior coil constructions operate satisfactorily, they have inherent drawbacks which make them unsuitable for use as a secondary coil mounted on a vehicle for inductive charging. The present invention was developed in order to overcome these and other drawbacks of the prior devices by providing an improved coil construction which can be conformed to a surface of the vehicle on which it is mounted, thereby minimizing its protrusion from the vehicle, while also providing efficient energy transfer from a stationary primary coil of an inductive charging system.

### SUMMARY OF THE INVENTION

Accordingly, it is a primary object of the invention to provide a secondary coil for an electric vehicle charging system including a first sheet of material having top and bottom surfaces and a coil connected with the top surface of the first sheet and having an axis normal to the plane containing the first sheet. A second sheet of material having top and bottom surfaces is connected with the first sheet with the coil arranged between the second sheet bottom surface and the first sheet top surface to form a planar coil structure. The structure is configured to match the configuration of a component of the vehicle with which the coil structure is connected.

The coil generates a magnetic field when current flows through the coil. The field created by the planar coil construction in the area of the vehicle body has a lower maximum value than that created by a conventional construction, thereby reducing heat generated in the vehicle body.

The sheets of material are formed of a synthetic plastic material which retains a configuration when in a normal state. However, when the material is heated, it may be contoured to match the configuration of the vehicle component. The material will retain its contoured configuration when cooled to the normal state.

In a preferred embodiment, the first sheet contains an annular recess for receiving the coil and the coil comprises a plurality of generally co-planar windings or turns of metal wire.

In a further embodiment, the coil is in the form of a circuit printed on the top surface of the first sheet. Multiple sheets of material are provided, each having a coil circuit printed on a top surface thereof. The coils are coaxial and electrically connected in parallel, and the sheets are laminated together to form the secondary coil structure.

### BRIEF DESCRIPTION OF THE FIGURES

Other objects and advantages of the invention will become apparent from a study of the following specification when viewed in the light of the accompanying drawing, in which:

FIG. 1 is a schematic diagram of an inductive vehicle charging system according to the invention;

FIG. 2 is a schematic diagram of the components of the inductive charging system according to the invention;

FIG. 3 is an exploded perspective view of the secondary coil assembly according to a preferred embodiment of the invention;

FIGS. 4a is a front view of the coil arrangement of an inductive charging system mounted on a vehicle utilizing a secondary coil according to the prior art;

FIG. 4b is a detailed view of the arrangement of the secondary coil of FIG. 4a adjacent to the primary coil;

FIG. 5a is a front view of the coil arrangement of an inductive charging system mounted on a vehicle utilizing a secondary coil assembly according to the invention;

FIG. 5b is a detailed view of the arrangement of the secondary coil of FIG. 5a adjacent to the primary coil;

FIG. 6 is a bottom view of a vehicle showing the secondary coil assembly mounted thereon;

FIG. 7 is a bottom view of an underbody component of a vehicle having the secondary coil assembly molded therein;

FIGS. 8 and 9 are schematic illustrations of the magnetic fields generated by the secondary coil structures of FIGS. 4 and 5, respectively;

FIG. 10a is a schematic illustration of the arrangement of secondary coils according to the prior art and according to the invention relative to a vehicle;

FIG. 10b is a graph representing the magnetic field strength of the two prior art and inventive secondary coils taken along line A-A of FIG. 10a; and

FIG. 11 is an exploded perspective view of the secondary coil structure according to an alternative embodiment of the invention.

### DETAILED DESCRIPTION

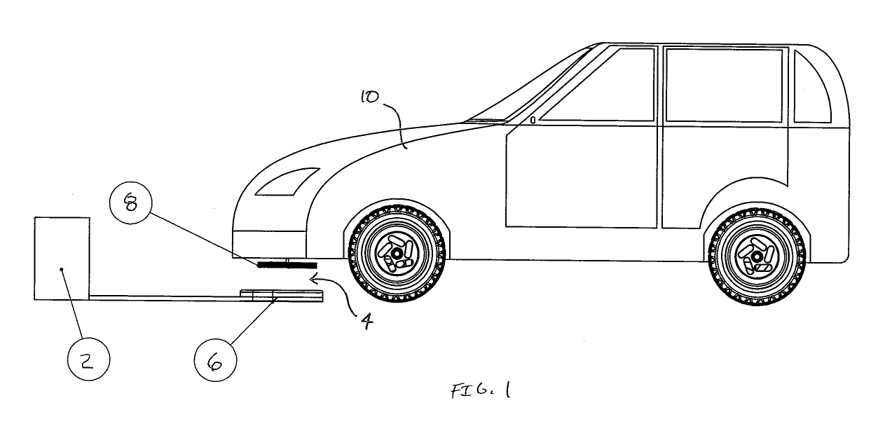

Referring first to FIG. 1, there is shown an inductive charging system for electric vehicles. The system includes a charging station 2 and a transformer 4. The transformer includes a stationary primary coil 6 which is preferably mounted on the ground such as the floor of a garage. The primary coil is connected with the charging station. The transformer further includes a secondary coil 8 which is mounted on a vehicle 10. The secondary coil is mounted at a location on the vehicle so that the vehicle can be positioned adjacent to the charging station with the secondary coil above the primary coil as shown. Preferably, the coils are arranged with their axes in alignment for maximum energy transfer there between. The charging station 2 is connected with a power source 12.

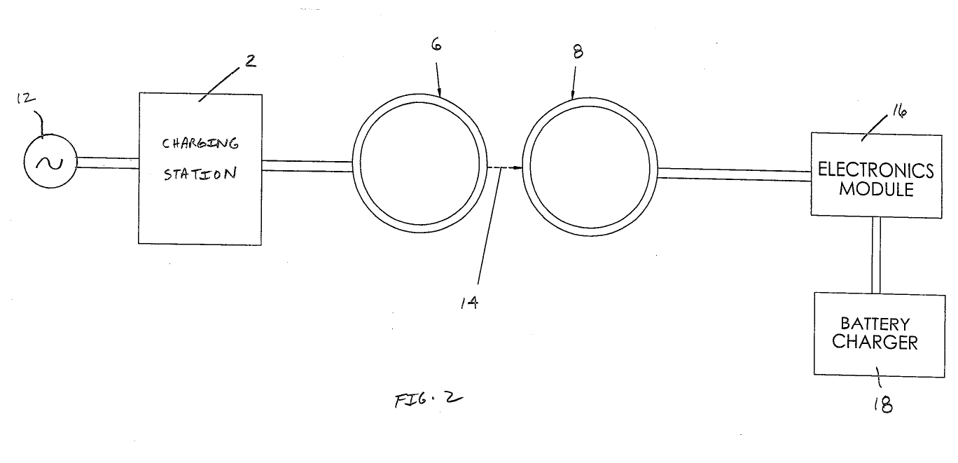

The inductive charging system according to the invention will be described in greater detail with reference to FIG. 2. The charging station 2 is connected with a power source 12. The power source is preferably a 220 volt AC supply operating at between 50 and 60 Hz. The charging station 2 includes a power converter which converts the incoming source voltage from the power supply into a voltage of arbitrary frequency and voltage. The voltage is supplied to the stationary primary coil 6. Current within the primary coil generates a magnetic field 14 which induces a current in the secondary coil 8 mounted on the vehicle. This in turn produces an output voltage which is processed by an electronics module 16 and delivered to a battery charger 18 in the vehicle to charge the vehicle battery. Thus, the inductive charging system exploits resonant circuit properties of the primary and secondary coils to wirelessly transfer energy to the vehicle's on-board battery charger.

Referring now to FIG. 3, the preferred embodiment of the secondary coil assembly 8 will be described. A sheet of synthetic plastic material 20 has a top surface 20a and a bottom surface 20b. The sheet has a thickness on the order of 5 mm. The top surface 20 of the sheet contains a groove or recess 22 configured to receive a coil 24. The coil is formed by winding a conventional conductor or Litz wire into a given pattern such as an elongated oval as shown. The successive turns of the winding are generally arranged in the same plane. The coil preferably has a thickness of less than 5 mm so that the upper surface of the coil does not extend beyond the top surface 20a of the sheet. A second sheet 26 of synthetic plastic material having top 26a and bottom 26b surfaces is provided to cover and protect the coil and first sheet. The coil 24 is thus arranged between the bottom surface 26b of the second sheet 26 and the top surface 20a of the first sheet 20. The sheets are joined and sealed in a conventional manner to form the secondary coil.

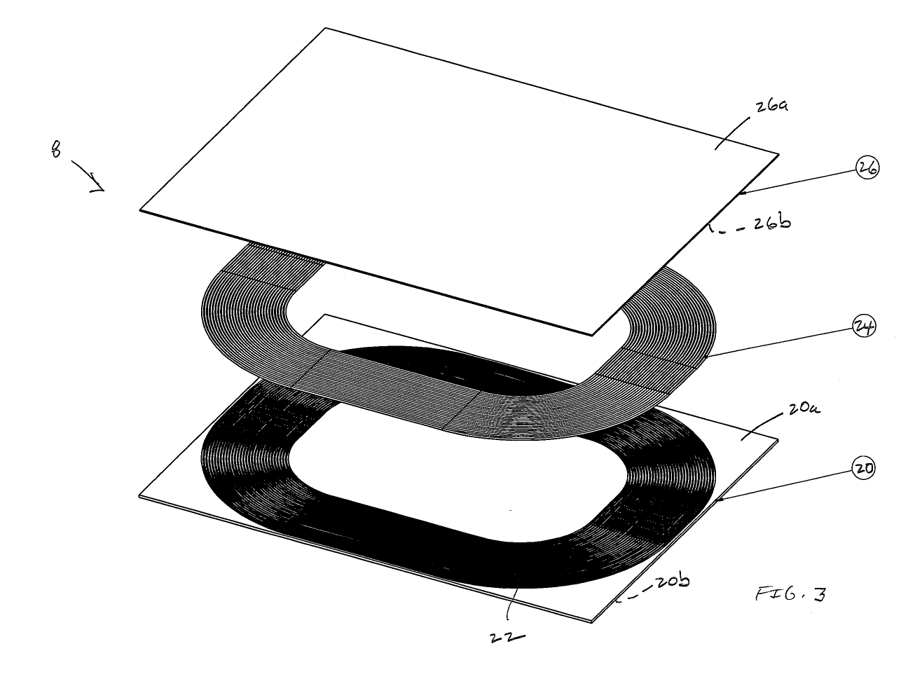

FIG. 4a shows the mounting of a secondary coil 108 beneath a vehicle 110 with the vehicle positioned above the primary coil 106 according to the prior art. As shown in detail in FIG. 4b, the secondary coil 108 is suspended beneath the vehicle on a mounting device which is attached to the vehicle for proximity to the primary coil 106. The addition of a coil of wire of significant size and weight to the underside of a vehicle negatively affects the weight, efficiency, performance, and aerodynamics of the vehicle. In addition, it reduces the ground clearance and crashworthiness of the vehicle.

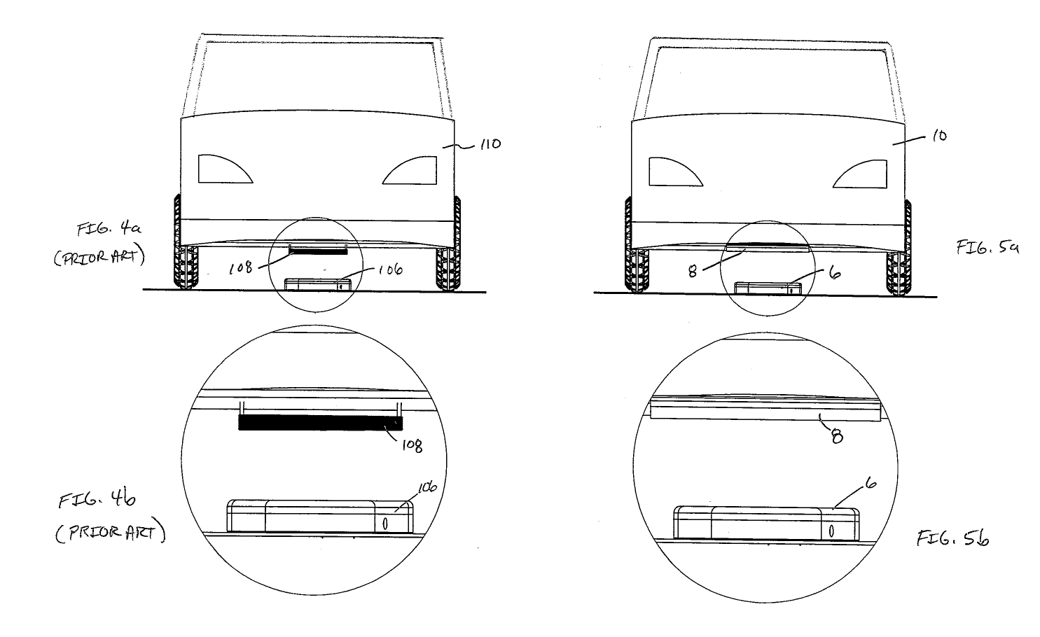

FIG. 5a shows the mounting of a secondary coil 8 according to the invention beneath the vehicle 10. As compared with the mounting shown in FIG. 4a, the coil is thinner and mounted directly onto the vehicle underbody as shown in FIG. 5b. Alternatively, as will be developed below, the coil assembly can also be molded directly into the vehicle underbody so that it is integral with the underbody.

A unique feature of the coil construction according to the invention is that the coil can be molded or shaped into different configurations. Thus, when the sheets are heated, they become pliable so that the entire coil assembly can be contoured to match the contour of the surface on which the coil assembly is to be mounted. Typically, this is the underside of a vehicle. A significant portion of the underbody of a vehicle is covered by a synthetic plastic resin designed to enhance the aerodynamics of the vehicle and provide protection from road debris.

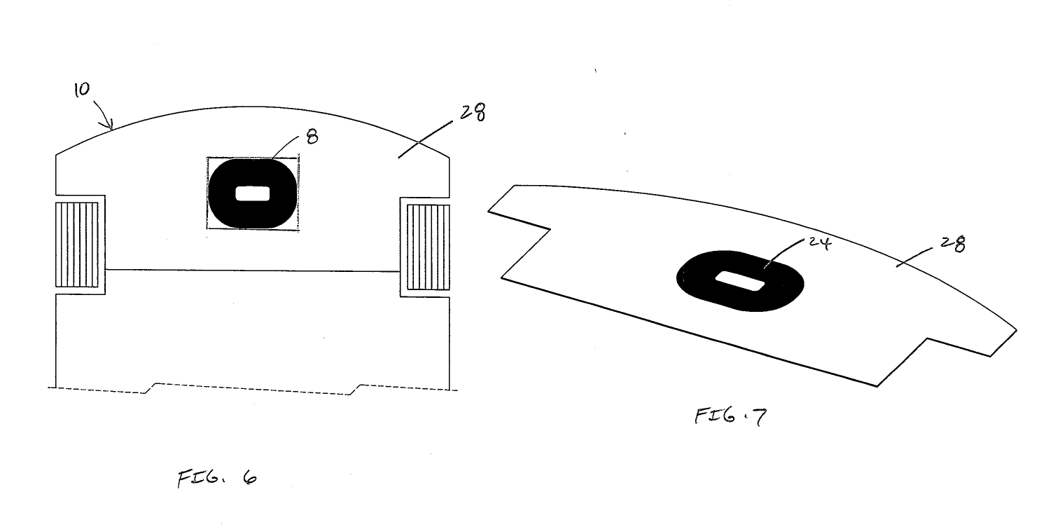

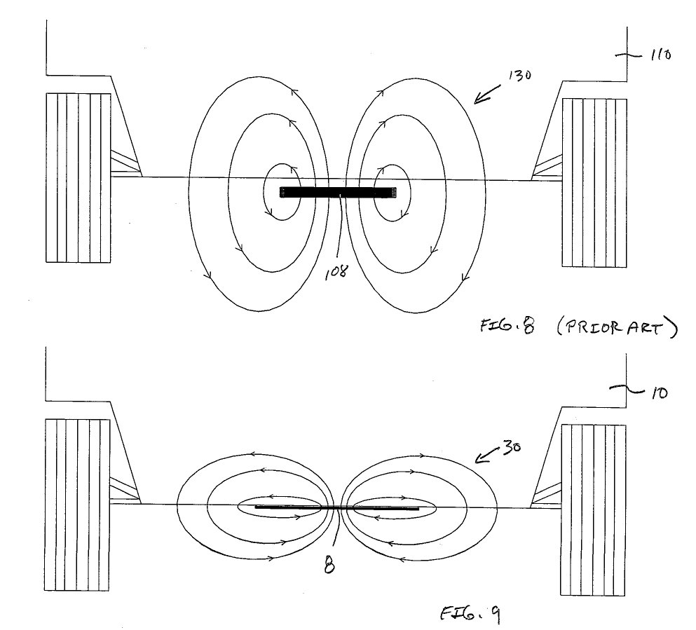

FIG. 6 shows the secondary coil assembly 24 mounted on the underbody 28 of the vehicle 10. This increases the ground clearance of the vehicle as compared with secondary coils of the prior art which project beyond the vehicle underbody. The underbody need not have a planar configuration. Because the coil assembly 8 is relatively thin, i.e. less than 10 mm, and includes moldable synthetic plastic sheets it can be contoured to match a curvature of the underbody. Alternatively, the coil 24 which has a thickness of less than 5 mm can be molded directly into the underbody as shown in FIG. 7 where the underbody is formed of a synthetic plastic material. Either embodiment does not detract from the aerodynamics or ground clearance of the vehicle.

FIG. 8 is a schematic cross sectional illustration of a conventional donut coil 108 mounted on a vehicle 110 showing the magnetic field 130 generated by the coil when current passes through the coil windings. The magnetic field interacts with the vehicle's steel components resulting in heating of the steel and reducing the efficiency of the inductive charging system. It is therefore advantageous to reduce the magnetic field in the area above the coil 108 where steel components may exist.

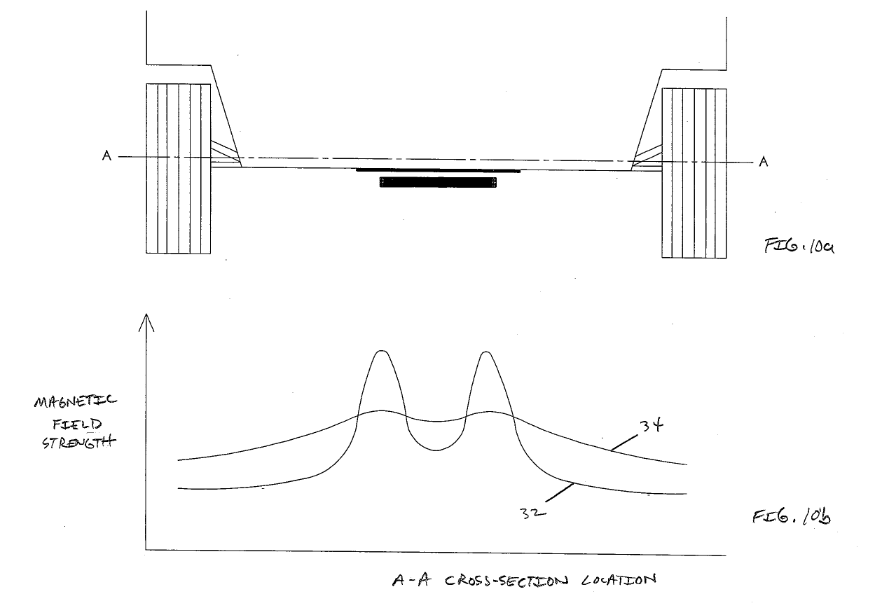

FIG. 9 is a schematic cross sectional illustration of a coil 8 according to the invention mounted on a vehicle 10 showing the magnetic field 30 generated by the coil.

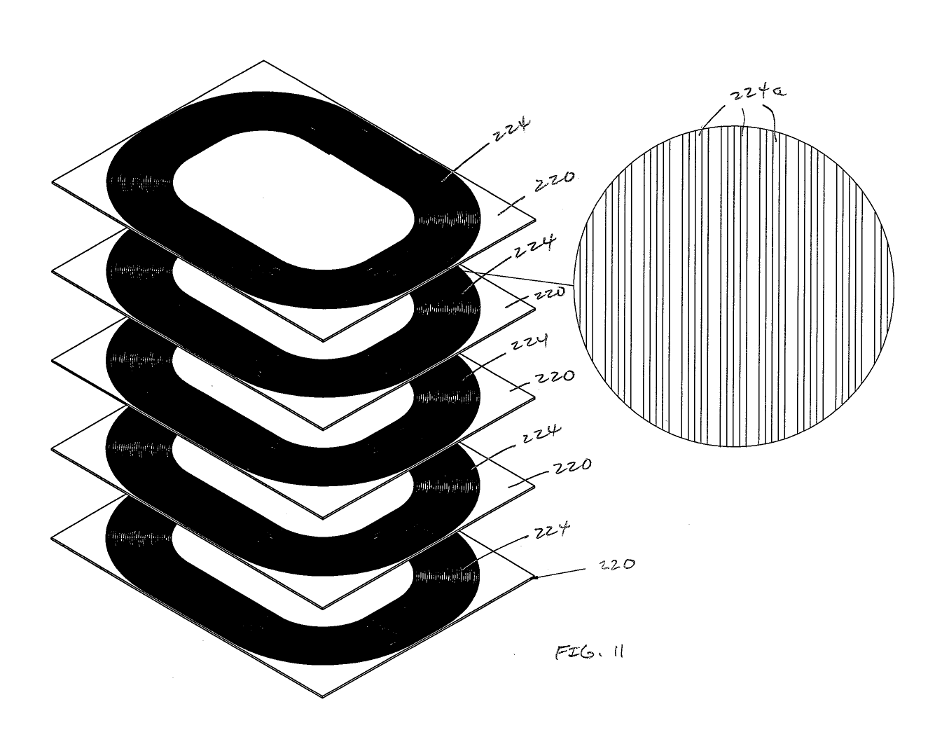

FIG. 10a is a composite drawing based on FIGS. 8 and 9 showing a donut coil 108 and a planar sheet coil 8 according to the invention mounted on a vehicle. FIG. 10b is a graphical representation of the magnetic field strength created by each coil along the line A-A of FIG. 10a. More particularly, the line 32 shows the magnetic field strength of the donut coil at locations along the line A-A and line 34 shows the magnetic field strength of the planar sheet coil at the same locations. The plot was created using coils carrying the same current and transferring the same power. The plot lines indicate the relative field strengths created by the two coil constructions in the general vicinity immediately above the coils where steel components exist. The line 34 shows that the planar sheet coil 8 according to the invention introduces a lower maximum magnetic field to the area immediately above the coil. It also produces higher magnetic field strengths compared to the prior donut coil construction where the filed strength is lower. Since the losses introduced in steel are an exponential function of field strength, a reduction by half of the maximum field is advantageous even if the regions of minimum strength are increased.

Referring now to FIG. 11, an alternate embodiment of a planar sheet secondary coil 208 will be described. In this embodiment, a plurality of sheets 220 of synthetic plastic material are provided, with each sheet having a circuit 224 forming a coil shape printed thereon. Preferably, each printed circuit is identical and coaxially arranged with the other printed circuit coils. The printed circuits are preferably connected in parallel. The multiple layers of identical flexible printed circuits connected in parallel define a coil 208 with a thin overall construction but with adequate ampicity. For example, the coil construction may comprise five layers of material each having a printed coil circuit on a top surface thereof. Each sheet has a thickness of approximately 20 mil and contains a printed coil circuit with an ampicity of 3 Amperes. The thickness of the entire construction would be 0.1 inch with an ampicity of 15 Amperes. Of course, greater or fewer substrate layers may be provided as desired. The substrate layers are preferably laminated into a coil structure which can be contoured to match the configuration of a vehicle surface to which it is mounted in the same manner as the coil construction 8 of FIGS. 3, 6 and 7.

To reduce high frequency losses due to proximity and skin effects, the printed coil circuit for each layer may comprise multiple parallel traces 224a for each layer as shown in the detailed portion of FIG. 11. The traces are preferably laterally spaced on the top surface of each sheet 220.

The construction of a secondary coil structure utilizing multiple layers of individual thin layers of conductive material is advantageous in electric vehicle charging systems for a number of reasons.

First, a construction utilizing multiple, individual, parallel conducting paths reduces high frequency resistance per unit volume of conducting material by increasing the ratio of the surface area to cross-sectional area of the conductor. This reduces both the skin effect and proximity losses which are normally high due to the high frequency currents utilized in an inductive charging device. The skin effect can be further reduced by using multiple parallel traces for each circuit layer.

Second, by printing the circuit on a pliable surface, the surface can be molded to the shape of the location on the vehicle to which it is mounted. This reduces or eliminates any reduction of ground clearance introduced by the coil, as well as minimizes the increase in aerodynamic drag that would be introduced by the addition of an object of appreciable size on the underside of the vehicle.

Third, by configuring the secondary coil in a layered or stacked pancake configuration, the maximum magnetic field due to the secondary current is significantly reduced in the vicinity of the coil, relative to the donut coil design in which all of the coil turns are located within a smaller cross sectional area. This reduces induced currents and hysteresis losses in adjacent metallic components, allowing more flexibility in the mounting location of the coil without increasing parasitic losses.

Although the printed coil circuits of the coil construction of FIG. 11 are preferably connected in parallel, they my also be connected in series to accommodate high voltage, low current loads.

While the preferred forms and embodiments of the invention have been illustrated and described, it will become apparent to those of ordinary skill in the art that various changes and modifications may be made without deviating from the inventive concepts set forth above.

What is claimed is:

1. A secondary coil for an electric vehicle charging system, comprising
(a) a first sheet of material having top and bottom surfaces;
(b) a coil connected with said top surface of said first sheet, said coil having an axis generally normal to a plane containing said first sheet;
(c) a second sheet of material having top and bottom surfaces, said second sheet being connected with said first sheet with said coil arranged between said first sheet top surface and said second sheet bottom surface to form the secondary coil structure, the secondary coil structure being configured to match the configuration of a component of the vehicle with which the secondary coil structure is connected.

2. A secondary coil as defined in claim 1, wherein said coil generates an elongated magnetic field when current is induced therein, said magnetic field being of a lower maximum value than that created by a conventional winding when both coils are energized with the same current, thereby to minimize heat generated in the vehicle body.

3. A secondary coil as defined in claim 2, wherein said first and second sheets of material are formed of a synthetic plastic material which retains its configuration when in a natural state and which when heated can be contoured to match the configuration of the vehicle component.

4. A secondary coil as defined in claim 3, wherein said first sheet top surface contains an annular recess for receiving said coil.

5. A secondary coil as defined in claim 4, wherein said coil comprises a plurality of windings of metal wire.

6. A secondary coil as defined in claim 5, where said windings are generally co-planar.

7. A secondary coil as defined in claim 3, wherein said coil comprises a printed circuit printed on said top surface.

8. A secondary coil as defined in claim 7, and further comprising a plurality of sheets of material each having a coil circuit printed on a top surface thereof, said coil circuits being coaxial.

9. A secondary coil as defined in claim 8, wherein said printed circuits of each coil are electrically connected in parallel.

10. A secondary coil as defined in claim 9, wherein each coil circuit comprises a plurality of windings.

11. A secondary coil as defined in claim 10, wherein said windings are arranged in laterally spaced groups of windings.

12. A secondary coil as defined in claim 11, wherein said windings are vertically aligned.

13. A secondary coil as defined in claim 12, wherein said sheets of material are laminated together to form said coil structure.
